(19) United States
(12) Patent Application Publication
(10) Pub. No.: US 2023/0155413 A1
(43) Pub. Date: May 18, 2023

(54) INVERTER HAVING A BISTABLE SWITCHING UNIT

(71) Applicant: SMA Solar Technology AG, Niestetal (DE)

(72) Inventor: Claus Allert, Kaufungen (DE)

(21) Appl. No.: 18/099,506

(22) Filed: Jan. 20, 2023

Related U.S. Application Data
(63) Continuation of application No. PCT/EP2021/069397, filed on Jul. 13, 2021.

(30) Foreign Application Priority Data
Jul. 23, 2020 (DE) 10 2020 119 481.1

(51) Int. Cl. H02J 9/06; H02M 7/797

(52) U.S. Cl. CPC H02J 9/062; H02M 7/797

(57) ABSTRACT

An inverter includes a battery terminal configured to connect to an electrical storage unit, a load terminal configured to connect to at least one electrical-energy consumer, and a grid terminal configured to connect to a superordinate distribution grid. The inverter also includes a bidirectional inverter bridge connected to the battery terminal, a first switching circuit, and a second switching circuit. The first switching circuit is arranged between the bidirectional inverter bridge and the second switching circuit, and the second switching circuit is arranged between the first switching circuit and the grid terminal. The first switching circuit is configured to enter a first state without a holding current and to switch into a second state with a holding current, and the second switching circuit is configured to be switched over between the first and second states by a signal.

### CROSS REFERENCE TO RELATED APPLICATIONS

This application is a continuation of International Patent Application Number PCT/EP2021/069397, filed on Jul. 13, 2021, which claims priority to German Patent Application number 10 2020 119 481.1, filed on Jul. 23, 2020, and is hereby incorporated by reference in its entirety.

### FIELD

The disclosure relates to an inverter with terminals to an electrical storage unit, to at least one consumer and to a superordinate distribution grid, the inverter comprising a bidirectional inverter bridge and a series connection of two switching units.

### BACKGROUND

Inverters are power electronics devices that are configured to convert between a direct current and an alternating current. In particular, inverters which can feed electrical power from a DC source, for example, a photovoltaic generator, into an AC voltage grid, or can bidirectionally exchange electrical power between a DC storage device, for example, a battery, and an AC voltage grid are known.

Also known are so-called emergency power, backup power or backup systems that protect connected consumers in the event of a power failure. To do this, a series of switching operations must be carried out, for example, a disconnection from the grid, a grid former start up and the connection of the latter to the supply lines to the consumers. Furthermore, the state of the grid has to be monitored to initiate synchronization of the possibly present local generators and to be able to reconnect the system to the grid, for example, when the grid returns. These and many other requirements have to be met, the meeting of which is regulated in different countries with a wide variety of directives, norms and standards.

In particular, the disclosure relates to relatively small backup power systems which are only intended to supply power to a few loads. Backup power systems of this kind are used, for example, in superordinate distribution grids that have a high level of stability, meaning that that these superordinate distribution grids guarantee the supply of power to the loads without disruption more than 90% of the time. Conversely, this means that backup power systems provided in this way are kept permanently ready for operation, but are only used very rarely. The backup power system, usually the inverter contained therein, usually comprises a controller that both monitors the state of the grid and controls the switches for changing over from grid operation to backup power operation.

For safety reasons, switches that are open in the idle state are usually used, so-called normally open switches, often also integrated into the inverter. However, this solution has the disadvantage that in stable grids, these switches have to be actively kept closed 98% or more of the time, which incurs a considerable demand for energy. This is all the more significant in small systems, where, for example, only one consumer needs to be protected in the event of a grid fault, which moreover in certain circumstances occurs only very rarely.

A circuit arrangement with a bistable relay between a grid and an inverter is known from EP 2 141 781 B1, the energy for the safety-relevant switching off of the relay being ensured by a pre-charged capacitor.

Document DE 10 2010 000502 A1 discloses a backup power system for connection to a supply grid with a TT grid topology. The backup power system comprises a control device, a switch-over device, a PV inverter, a consumer, a residual-current circuit breaker connected upstream of the consumer, a battery inverter and a generator. In this case, the switch-over device has an electrical resistance RN-PE which establishes an electrical connection between a local PE potential and an N potential in such a way that a fault current flowing in the event of a fault results in the consumer being switched off correctly by the residual-current circuit breaker.

Document DE 10 2018 130453 A1 discloses a method for electrically supplying an inverter with an AC voltage. The inverter includes an AC output for connecting an AC grid, a DC input for connecting a DC source, a DC/AC converter and a control unit for controlling the DC/AC converter. The control unit is connected to a switching unit, by means of which the control unit is supplied via the AC grid in a first switching state and via an auxiliary energy source providing an AC voltage in a second switching state. The inverter also has a grid monitoring unit for detecting an AC voltage present in the AC grid. In the method, the switching unit is operated in the second switching state if a grid monitoring unit-detected property of the AC voltage prevailing in the AC grid does not meet predetermined criteria. Then again, the switching unit is operated in the first switching state if a grid monitoring unit-detected property of the AC voltage prevailing in the AC grid meets the predetermined criteria.

### SUMMARY

There is a need for backup power systems, in particular for use in stable grids, which can be designed to be small and inexpensive and also incur low costs in standby mode.

An inverter according to the disclosure comprises a battery terminal configured to connect at least one electrical storage unit, for example, a battery, a load terminal configured to connect a load, for example, at least one electrical-energy consumer, and a grid terminal for a connection to a superordinate AC distribution grid, which is also referred to as distribution grid below. The inverter also comprises a bidirectional inverter bridge that is connected to the battery terminal on its DC side. Furthermore, the inverter according to the disclosure comprises a first switching circuit and a second switching circuit, the first switching circuit being arranged between the AC side of the bidirectional inverter bridge and the second switching circuit, and the second switching circuit being arranged between the first switching circuit and the grid terminal. The first switching circuit is configured to enter a first state without a holding current and to switch into a second state with a holding current. The second switching circuit is configured to be switched over by a signal.

In one embodiment, the switching function between the inverter bridge and the distribution grid is carried out redundantly using two series-connected switches. This ensures that even if one switch malfunctions, the grid disconnection can still be reliably implemented by the other switch. Here, one of the switches is implemented by a switching circuit configured to be switched over by a signal, meaning that the switching circuit can have a plurality of stable states, with the transition from one state to the other state being able to be triggered by a signal. By contrast, if one of the stable states has been reached, the second switching circuit remains in the respectively present stable state of its own accord and in the absence of a signal. Such a signal can be provided, for example, by a controller of the inverter. In the case of the first switching circuit, the second state is actively maintained by way of a holding current and hence giving rise to energy losses. Then again, it falls into its first state of its own accord and maintains the latter without giving rise to energy losses in the process. The behavior of the first switching circuit therefore corresponds to that of a monostable switching circuit. In contrast, in the case of the second switching circuit, each of the stable states can be maintained of its own accord without the second switching circuit giving rise to energy losses. In the case of the second switching circuit, a signal and a loss of energy associated therewith are only required for a change between two different stable states. The behavior of the second switching circuit corresponds to the behavior of a multistable switching circuit, for example, a bistable switching circuit.

In one embodiment, the first switching circuit of the inverter is open in the first state and closed in the second state. This is also referred to as a “normally open” switching circuit. The first switching circuit can thus be configured as a normally open switch and the second switching circuit can be configured as a bistable switching circuit which remains in a previous state without a signal. In this way, the second switching circuit can be switched between an open and closed state by the application of a signal. This signal may have only a short duration, meaning that only little energy has to be expended for the switchover. The inverter thus comprises a bidirectional inverter bridge and a series circuit made up of a monostable switching circuit and a bistable switching circuit. The inverter, in one embodiment, has a controller that is configured to generate the signal for switching over the second switching circuit.

Although a multistable switching circuit, for example, a bistable switching circuit, is usually more expensive in procurement than a monostable switching circuit, it is associated with a lower energy loss during operation of the switching circuit. In the case of the inverters in question, it was found that an optimal compromise between saving energy during operation and low production costs arises when the first switching circuit is configured as a monostable switching circuit and the second switching circuit is configured as a multistable switching circuit, for example, a bistable switching circuit. With the second switching circuit configured to be multistable or bistable, it is thus possible to connect consumers connected to the load terminal to the distribution grid for a relatively long period of time without this giving rise to energy losses associated with the switching circuit, or with this giving rise to only negligible energy loss associated with the switching circuit. This is the case most of the time, especially in the case of strong distribution grids that only have minor power failures.

The design of the switching circuits according to the disclosure, specifically configuring the first switching circuit as a monostable switching circuit and the second switching circuit as a multistable switching circuit, for example, a bistable switching unit, also allows the DC/AC converter to be intermittently disconnected from the distribution grid and switched to a sleep mode for further savings of energy. This may occur, for example, when the connected battery is currently empty or fully charged, or a PV generator connected to the inverter on the DC side is not currently producing any electrical power. By bringing about the sleep mode for the inverter, the first switching circuit enters into its first state, that is to say its open state, of its own accord. In this case, the consumers connected to the load terminal can continue to be supplied by the distribution grid when the second switching circuit is closed, without the second switching circuit giving rise to energy losses within the scope of maintaining its closed state in the process.

In a further embodiment of the disclosure, a so called “single-fault safety” can be implemented. The “single-fault safety” corresponds to the requirement that a single fault must not lead to the loss of the safety function. For this purpose, the correct function of the second switching circuit is monitored by the controller of the inverter. In this case, the monitoring can be carried out, for example, by measuring the voltage between the first and second switching circuits. If the second switching circuit malfunctions, the controller of the inverter can implement grid disconnection by controlling the first switching circuit. If the controller fails, the first switching circuit is opened automatically since the first switching circuit is configured as a normally open switch. This means that a safe grid disconnection can be implemented if a fault occurs.

In one embodiment, the inverter also has a grid monitoring circuit or an interface for connecting a grid monitoring circuit. The grid monitoring circuit is configured to measure grid parameters of the superordinate distribution grid and to be communicatively connected to the controller. The controller is configured to be communicatively connected to the grid monitoring circuit and to receive grid parameters of the superordinate distribution grid from the grid monitoring circuit. The grid monitoring circuit can be contained in the inverter or be configured as a separate circuit. It is configured to measure the grid parameters at the grid terminal or in the vicinity of the grid terminal. The measurement in the vicinity of the grid terminal is carried out outside the inverter, in one embodiment.

In one embodiment, the controller is configured to generate the signal for switching over the second switching circuit to the open state should a failure of the superordinate distribution grid be detected by grid parameters received from the grid monitoring circuit. This disconnects the inverter from the superordinate distribution grid. If the second switching circuit was already open before the signal for switching over was received, the second switching circuit remains in the open state.

The load terminal of the inverter is connected to connection points which are arranged between the first switching circuit and the second switching circuit. One or more consumers of electrical energy can be connected to the load terminal. In the event of a power failure, these consumers should be supplied with energy from the connected electrical storage circuit, for example, the rechargeable battery, via the inverter. As an alternative or in addition, consumers should be supplied with energy from a generator, for example a photovoltaic generator, in the event of a power failure. In this case, the generator can be connected to the battery terminal or to the connection points. The consumer or consumers can be supplied from the generator via the inverter or directly or via a further voltage converter.

Since the connection points are arranged between the first switching circuit and the second switching circuit, a connection can be established between the consumers connected to the load terminal and the distribution grid by means of the second switching circuit. If the superordinate distribution grid is functioning correctly, the second switching circuit can be closed, for example, using a short switching pulse, if it is not already closed, and the consumers can be supplied from the distribution grid. The inverter according to the disclosure thus saves energy, especially in very stable distribution grids.

In one embodiment, the inverter is configured to supply the connected consumer in the event of a power failure, that is to say it is configured to establish a local island grid. This is advantageous, in one embodiment, in the case of a failure of the superordinate distribution grid. A local island grid is a locally delimited power supply grid that supplies a small spatial area and is usually operated locally, that is to say without a direct electrical connection to other power supply grids.

In one embodiment, the controller is configured to provide a sign-of-life signal and transmit the latter to the second switching circuit. This enables the implementation of a safety feature by virtue of the second switching circuit being informed that the controller is in order and is functioning correctly. The sign-of-life signal can be a “high” potential or a pulsed signal, for example.

In one embodiment, the second switching circuit is configured to switch into the closed state when it receives the sign-of-life signal, for example, the second switching circuit is configured to switch into the closed state only when it receives the sign-of-life signal. In one embodiment, the word “only” means that the switching circuit is configured to switch into the open state or to maintain the open state when it does not receive the sign-of-life signal. This allows the safety to be increased, since the load of the inverter is then connected to the superordinate distribution grid if the inverter controller is in order and communicates this by way of the sign-of-life signal.

In one embodiment, the implementation of “single-fault safety”, for example, is enabled. The inverter uses the grid monitoring circuit to monitor the distribution grid and switches the load, for example the consumers, to the superordinate distribution grid. The grid quality is monitored, as a result of which a failure of the distribution grid, for example, can be determined. The second switching circuit disconnects the load from the distribution grid if it is actively switched into the open state by the controller, for example, due to poor grid quality, or if it is not certain that the controller is working correctly, that is to say, for example, if the sign-of-life signal is missing. The two aforementioned signals to the second switching circuit can be two separate signals or they can be the same signal, which combines both pieces of information.

In one embodiment, the second switching circuit is configurable, with the second switching circuit comprising a control circuit which is configured to receive configuration signals and to configure the second switching circuit using the configuration signals. By way of example, certain states of the second switching circuit can be triggered in a targeted manner using the configuration signals.

In one embodiment, the control circuit is configured to receive the configuration signals from the controller, with the controller for its part being configured to transmit the configuration signals to the control circuit. In embodiments, the configuration signals may configure one or more of the following states of the second switching circuit, for example, in response to specific events:
the second switching circuit remains in the closed state;
the second switching circuit remains in the open state;
the second switching circuit switches into the open state if it does not receive a sign-of-life signal.

A second switching circuit which switches into the open state if it does not receive a sign-of-life signal could be implemented, for example, as described in EP 2 141 781 B1, discussed supra.

Another possible configurable state is that the second switching circuit remains in the closed state even if the sign-of-life signal is missing. This may be expedient if the inverter is switched off, for example, because the battery is empty, and the load should therefore remain connected to the superordinate distribution grid.

A further possible configurable state is that the second switching circuit also remains in the open state independently of the grid state and/or a sign-of-life signal. Hence, the load can remain separated from the superordinate distribution grid.

The disclosure thus enables a simple and energy-saving realization of different operating states of the inverter via the different switch positions of the first and second switching circuits.

In one embodiment, the inverter comprises a generator terminal configured to connect to a generator for producing electrical energy. The generator terminal in one embodiment is connected to the DC side of the inverter bridge directly or via a DC-DC converter. The generator terminal can thus correspond to the battery terminal, for example. The generator terminal can also be coupled to the AC side and, for example, linked to the connection points. In the event of a failure of the superordinate distribution grid, the load can thus be supplied with electrical energy via the generator.

A method for supplying at least one consumer connected to a load terminal of an inverter with electrical energy includes detecting, using a grid monitoring circuit, the state of the superordinate distribution grid connected to the grid terminal, and reporting a failure to the controller of the inverter. In the event of failure of the superordinate distribution grid, the controller generates a signal to switch over the second switching circuit into the open state, whereupon the second switching circuit is opened in the next act. The first switching circuit is then optionally closed or remains closed. If the first switching circuit is already closed, it remains closed. If the first switching circuit is open, it is closed.

In this context, a failure of the distribution grid means such a widespread impairment of grid parameters that a reliable supply of the consumer or consumers is no longer guaranteed.

In the event of failure of the superordinate distribution grid in one embodiment of the method, the bidirectional inverter bridge establishes a local island grid and the at least one consumer connected to the load terminal is supplied with electrical energy via the inverter. In this case, the electrical energy can be obtained from an electrical energy store connected to the inverter and/or from a generator connected to the inverter.

The method makes it possible to disconnect the inverter from the superordinate distribution grid when necessary and to supply the load with electrical energy via an island grid established by the inverter.

### BRIEF DESCRIPTION OF THE FIGURES

The following text further explains and describes the disclosure with reference to example embodiments illustrated in the figures.

FIG. 1 schematically shows an embodiment of an inverter, and

FIG. 2 schematically shows a method for supplying at least one consumer with electrical energy.

### DETAILED DESCRIPTION

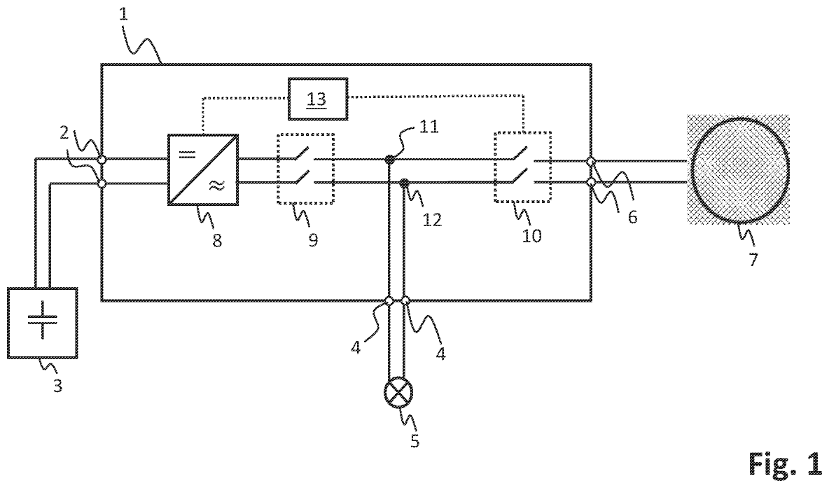

FIG. 1 shows an inverter 1 comprising a battery terminal 2 and an electrical storage unit 3, for example, a rechargeable battery, connected thereto. A consumer 5 is connected to a load terminal 4. A plurality of consumers 5 can also be connected to the load terminal. FIG. 1 also shows that the inverter 1 is connected to a superordinate distribution grid 7 via a grid terminal 6. The inverter 1 further comprises an inverter bridge 8 that is connected to the battery terminal 2 on its DC side. A first switching circuit 9 and a second switching circuit 10 are arranged between an AC side of the inverter bridge 8 and the grid terminal 6. The first switching circuit 9 is embodied as a monostable switch which is normally open. This means that it falls into, or enters, the open state without being actuated. If it is controlled by a control signal, for example, a holding current, it closes for as long as the control signal, that is to say the holding current for example, is applied. The second switching circuit 10 is embodied as a bistable switch in which both the open state and the closed state are stable, that is to say it remains in this state even without actuation. The second switching circuit 10 can change the state by way of a signal.

The connection points 11, 12 for the load terminal 4 are arranged between the first switching circuit 9 and the second switching circuit 10. One connection point 11, 12 is provided on each of the two AC lines in this case. Here, the first switching circuit 9 is arranged between the inverter bridge 8 and the connection points 11, 12 and the second switching circuit 10 is arranged between the connection points 11, 12 and the grid terminal 6. The inverter 1 further comprises a controller 13 which can control the electronic power switches of the inverter bridge 8. The controller 13 is also configured to generate one or more control signals for switching the second switching circuit 10 and to transmit them to the second switching circuit 10. In one embodiment, the controller 13 can also generate configuration signals for a control circuit (not shown) of the second switching circuit 10 and transmit these to the control circuit.

In one embodiment, the inverter additionally comprises a generator terminal configured to connect to a generator for producing electrical energy. The generator terminal (not shown) can be connected directly or via a DC-DC converter; for example, it can be connected to the DC side of the inverter bridge 8, or in the case of an AC side coupling, be linked to the points 11, 12, for example.

In one embodiment, the inverter 1 may comprise a grid monitoring circuit (not shown). The grid monitoring circuit is configured to measure grid parameters of the superordinate distribution grid 7, for example, at the grid terminal 6 or outside of the inverter in the vicinity of the grid terminal 6. A power failure, that is to say a failure of the superordinate distribution grid 7, can be determined by way of the grid parameters by means of the controller 13, for example. In one embodiment, the inverter 1 comprises a terminal for the grid monitoring circuit. In this embodiment, the grid monitoring circuit can be arranged outside the inverter 1.

If the first switching circuit 9 and the second switching circuit 10 are open, the distribution grid 7 is disconnected from the inverter 1. Hence there is no supply of the connected loads. The inverter 1 is voltage-free. This may be a desired state for maintenance work, for example.

If the first switching circuit 9 is open and the second switching circuit 10 is closed, then the inverter bridge 8 is separated from the distribution grid 7, but the consumer 5 is supplied from the distribution grid 7. In this state, the inverter 1 is in energy-saving mode, for example. By way of example, energy store 3 may be full and it is not necessary to supply the consumer 5 from the energy store 3. Alternatively, the energy store 3 is empty, for example, and should not be further discharged. In the case of a generator, for example, a photovoltaic generator (PV generator), which is connected to the AC side of the inverter bridge 8 at the connection points 11, 12, a photovoltaic inverter could additionally be connected between the PV generator and the connection points 11, 12, which photovoltaic inverter then supplies the consumer 5, for example, for its own consumption, or feeds excess energy into the distribution grid 7. This mode with the first switching circuit 9 open and the second switching circuit 10 closed, for example, as an energy-saving mode, can increase the energy efficiency and, as a result of reduced operating time, also the service life. For this operation, it is necessary to ensure that the first switching circuit 9 is actually open before the inverter 1 goes into the energy-saving mode and hence loses the controllability for the second switching circuit 10 and the latter then remains in the closed state as it is bistable. The inverter 1 being in the energy-saving mode can mean that, for example, the inverter bridge 8 and the controller 13 are in the energy-saving mode. The consumers 5 are then supplied from the distribution grid 7, at least for as long as the latter is able to do so. Thus, from the user's point of view, the system made up of inverter 1 and consumers 5 can behave like a system without a storage/backup function. If the inverter 1 wakes up again from the energy-saving mode, the controller 13 gains control over the first switching circuit and the second switching circuit 10. The controller 13 can then monitor the required connection conditions and close the first switching circuit 9 to supply the consumer 5/consumers 5 with electrical energy. If the distribution grid 7 fails in the energy-saving mode of the inverter 1, the inverter 1 can also be woken up by an external grid monitoring circuit (not shown), for example. The controller of the inverter is then given control over the first and the second switching circuits 9, 10. The controller 13 can then initially open the second switching circuit 10 and, to supply the consumer 5 via the battery and/or generator, close the first switching circuit 9.

If both the first switching circuit 9 and the second switching circuit 10 are closed, this is an operating state that is assumed over relatively long periods of time and in which the inverter bridge 8 and the consumer 5 are connected to the distribution grid 7. The electrical storage unit or circuit 3 is charged or discharged and the consumers can be supplied from the distribution grid 7, electrical storage unit 3 and/or possibly local production by the generator. Excess production by the generator either can be fed into the distribution grid 7 or serves to charge the energy store 3. If the generation by the generator does not suffice, energy from the energy store 3 and/or the distribution grid 7 is used to compensate for the difference to energy required by the consumer 5. This state is a sought-after state of electrical backup systems. Grid monitoring is carried out by the inverter 1 or a grid monitoring circuit connected thereto and there is a switchover to the backup operation in the event of grid faults. To switch over from this operating state to the backup operation, the second switching circuit 10 is opened and hence the consumer 5 and the inverter bridge 8 are disconnected from the distribution grid 7.

If the first switching circuit 9 is closed and the second switching circuit 10 is open, then the inverter 1 is in the backup operation that has just been described. Here, the consumer 5 is supplied via the inverter bridge 8 and the connection to the distribution grid 7 is opened for this purpose by virtue of the second switching circuit 10 being opened. Here, it is now necessary to ensure that switch 10 is only closed if the corresponding conditions for closing are present, consequently that the inverter 1 has ensured the controllability, for example by way of a functioning controller 13. If the grid return is detected, the inverter 1 can then close the second switching circuit 10 again, taking into account the connection conditions. The inverter 1 has control over the second switching circuit 10 by way of the controller 13.

The second switching circuit 10 is closed in operating states that can take up long periods of time. The present apparatus now makes it possible to keep the second switching circuit closed with very little or no energy expenditure due to the embodiment of the latter as a bistable switch, but nevertheless ensures that the second switching circuit 10 opens in the event of a fault.

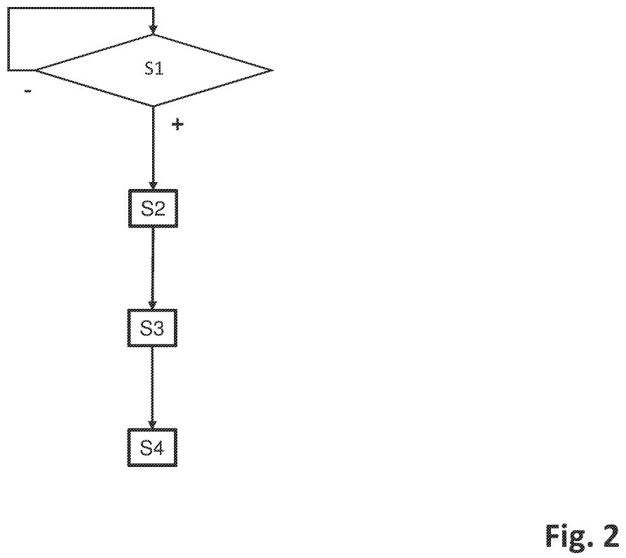

FIG. 2 schematically shows a method for supplying at least the consumer 5 with electrical energy. The consumer 5 is connected to the load terminal 4 of the above-described inverter 1.

At S1, a grid monitoring circuit detects the state of the superordinate distribution grid 7 connected to the grid terminal 6 and reports a failure—“yes” or “+” branch—to the controller 13 of the inverter 1 at S2. The monitoring is continued if no failure is detected—“no” or “−” branch. In this context, a failure means such a widespread impairment of grid parameters that a reliable supply of the consumer 5 is no longer guaranteed.

In the event of failure of the superordinate distribution grid 7, the controller 13 generates a signal at S3 to switch over the second switching circuit 10 into the open state. At S4, the second switching circuit 10 is then opened.

The bidirectional inverter bridge 8 subsequently establishes a local island grid and the at least one consumer 5 connected to the load terminal 4 is supplied with electrical energy.

What is claimed is:

1. An inverter comprising:
a battery terminal configured to connect to an electrical storage unit,
a load terminal configured to connect to at least one electrical-energy consumer,
a grid terminal configured to connect to a superordinate distribution grid,
a bidirectional inverter bridge connected to the battery terminal,
a first switching circuit, and
a second switching circuit,
the first switching circuit being arranged between the bidirectional inverter bridge and the second switching circuit, and the second switching circuit being arranged between the first switching circuit and the grid terminal,
wherein the first switching circuit is configured to enter a first state without a holding current and to switch into a second state with a holding current, and
the second switching circuit is configured to be switched over between the first and second states by a signal.

2. The inverter as claimed in claim 1, wherein the first switching circuit is open in the first state and closed in the second state and the second switching circuit is configured as a bistable switching circuit which remains in a previous state without a signal.

3. The inverter as claimed in claim 1, further comprising a controller configured to generate the signal for switching over the second switching circuit.

4. The inverter as claimed in claim 1, wherein the load terminal is connected to connection points arranged between the first switching circuit and the second switching circuit.

5. The inverter as claimed in claim 3, further comprising a grid monitoring circuit or an interface configured to connect the grid monitoring circuit, wherein the controller is configured to be communicatively connected to the grid monitoring circuit, and to receive grid parameters of the superordinate distribution grid from the grid monitoring circuit.

6. The inverter as claimed in claim 5, wherein the controller is configured to generate the signal for switching over the second switching circuit to an open state should a failure of the superordinate distribution grid be detected by grid parameters received from the grid monitoring circuit.

7. The inverter as claimed in claim 3, wherein the controller is configured to provide a sign-of-life signal and transmit the latter to the second switching circuit.

8. The inverter as claimed in claim 7, wherein the second switching circuit is configured to switch into a closed state when it receives the sign-of-life signal.

9. The inverter as claimed in claim 1, wherein the second switching circuit comprises a controller which is configured to receive configuration signals.

10. The inverter as claimed in claim 9, wherein the controller is configured to transmit the configuration signals to the control circuit, wherein the configuration signals triggering the following states:
the second switching circuit remains in the closed state,
the second switching circuit remains in the open state,
the second switching circuit switches into the open state if it does not receive a sign-of-life signal.

11. The inverter as claimed in claim 1, further comprising a generator terminal configured to connect to a generator for producing electrical energy.

12. A method for supplying electrical energy to at least one consumer connected to a load terminal of an inverter that comprises:
a battery terminal configured to connect to an electrical storage unit,
the load terminal configured to connect to at least one electrical-energy consumer,
a grid terminal configured to connect to a superordinate distribution grid,
a bidirectional inverter bridge connected to the battery terminal,
a first switching circuit, and
a second switching circuit,
the first switching circuit being arranged between the bidirectional inverter bridge and the second switching circuit, and the second switching circuit being arranged between the first switching circuit and the grid terminal,
wherein the first switching circuit is configured to enter a first state without a holding current and to switch into a second state with a holding current, and
wherein the second switching circuit is configured to be switched over by a signal, the method comprising:
detecting a state of the superordinate distribution grid connected to the grid terminal using a grid monitoring circuit and reporting a failure to a controller of the inverter, and
when the superordinate distribution grid fails:
generating via the controller a signal to switch over the second switching circuit into the open state, and
opening the second switching circuit.

13. The method as claimed in claim 12, wherein when the superordinate distribution grid fails:
establishing via the bidirectional inverter bridge a local island grid, and
supplying the at least one consumer connected to the load terminal with electrical energy.

14. The method as claimed in claim 13, wherein the consumer is supplied with electrical energy from an electrical storage unit connected to a battery terminal and/or from a generator connected to a generator terminal.
